(19) United States
(12) Patent Application Publication
(10) Pub. No.: US 2022/0155095 A1
(43) Pub. Date: May 19, 2022

(54) METHOD FOR VALIDATING AN UP-TO-DATENESS OF A MAP

(71) Applicant: Robert Bosch GmbH, Stuttgart (DE)

(72) Inventors: Anke Svensson, Braunschweig (DE); Carsten Hasberg, Ilsfeld-Auenstein (DE); Peter Christian Abeling, Hannover (DE); Tayyab Naseer, London (GB)

(21) Appl. No.: 17/601,994

(22) PCT Filed: Apr. 29, 2020
(86) PCT No.: PCT/EP2020/061885

§ 371 Date: Oct. 7, 2021

(30) Foreign Application Priority Data
May 17, 2019 (DE) 102019207218.6

(51) Int. Cl. G01C 21/00

(52) U.S. Cl. CPC G01C 21/3804

(57) ABSTRACT

A method for validating an up-to-dateness of a digital map by a control unit, the at least one digital map being received or retrieved. Measured data on the surroundings of the vehicle are received. A vehicle position within the at least one digital map is ascertained based on landmarks. Data of a driving assistance function are received. A comparison is carried out between the vehicle position within the at least one digital map and the data of the driving assistance function for validating the up-to-dateness of the at least one digital map. A transfer system, a control unit, a computer program as well as a machine-readable memory medium are also described.

### FIELD

The present invention relates to a method for validating an up-to-dateness of at least one digital map, in particular, by a control device, to a control device, to a computer program as well as to a machine-readable memory medium.

### BACKGROUND INFORMATION

Methods for the crowd-based mapping of roads negotiable by vehicles are available in the related art. In these methods, measured data of vehicle sensors are transferred to a server via a communication link. The transferred measured data of the vehicle sensors are collected on the server and maps for relevant road sections are generated from the data of multiple vehicles.

Such maps may be used, for example, for automated driving, in that the automatically driveable vehicles are able to ascertain their position within the map to utilize it for an automated navigation. Such a localization of vehicles may take place based on landmarks of the map.

In order to ensure a high accuracy and reliability of the localization, it is necessary to recognize possible changes of the negotiable vehicle surroundings in the map in a timely and robust manner. Previous methods for recognizing such changes are based on evaluations of satellite images and are associated with increased complexity.

### SUMMARY

An object underlying the present invention is to provide a method which is able to recognize changes of negotiable vehicle surroundings with respect to a map in a technically simple manner.

This object may be achieved with the aid of the present invention. Advantageous embodiments of the present invention are disclosed herein.

According to one aspect of the present invention, a method is provided for validating the up-to-dateness of at least one digital map. The method may be carried out preferably by a control unit on-board and/or off-board the vehicle.

In accordance with an example embodiment of the present invention, in one step, at least one digital map is received or retrieved. Measured data on the vehicle surroundings are received. The measured data may be received, in particular, by a vehicle sensor system, which may include radar sensors, LIDAR sensors, GNSS sensors, camera sensors or the like.

A vehicle position is ascertained on the basis of landmarks within the at least one digital map. For this purpose, landmarks may be extracted from the measured data of the vehicle sensors and detected within the at least one digital map.

In one further step, data of a driving assistance function are received. In this step, for example, a negotiability of a lane, a distance to lane markings, a distance to adjacent road users and the like may be received by the control unit. The data of the driving assistance function may be, in particular, a result of the driving assistance function.

To validate the up-to-dateness of the at least one digital map, a comparison is carried out between the vehicle position within the at least one digital map and the data of the driving assistance function.

According to one further aspect of the present invention, a control unit is provided, the control unit being configured to carry out the method. The control unit may, for example, be an off-board control unit or an off-board server unit such as, for example, a cloud system. The control unit may preferably be able to receive measured data of the vehicle sensor system of at least one vehicle. Alternatively or in addition, the control unit may be an on-board control unit, which is able to receive and evaluate measured data of the vehicle sensors.

In addition, a computer program is provided according to one aspect of the present invention, which includes commands which, upon execution of the computer program by a computer or a control unit, prompt the computer to carry out the method according to the present invention. According to one further aspect of the present invention, a machine-readable memory medium is provided, on which the computer program according to the present invention is stored.

The control unit may, for example, be installed in a vehicle, or may be able to communicate with a vehicle via a communication link. The vehicle in this case may be operable in an assisted, semi-automated, highly automated and/or fully automated or driverless manner according to the BASt standard.

The driving assistance function in this case may be able to access the measured data of the vehicle sensors or include inherent sensors for collecting measured data. A lane-keeping assistant, an emergency braking assistant, a distance-keeping assistant or the like may, for example, be used as a driving assistance function.

By the method, it is possible to implement a recognition of discrepancies or inconsistencies between digital maps and real vehicle surroundings. Such a recognition of discrepancies by localization maps and/or planning maps alone may be time-consuming, since this recognition is usually based on uncertain localization estimates. In contrast, the method according to the present invention utilizes the on-board localization estimate as well as pieces of information from driver assistance functions and merges these data, existing in parallel, with one another in order to recognize changes in localization maps and/or planning maps. Alternatively or in addition, the maps may be based on measured data of LIDAR sensors, radar sensors, camera sensors and the like.

A validation of a so-called HAD map up-to-dateness at the point in time of the localization of a vehicle may thus be carried out using driver assistance functions. Thus, it may be decided locally in a considered vehicle at the point in time of the localization whether a map update is necessary.

Depending on whether the validation is positive or negative, the vehicle may continue its travel or may no longer rely on the map used. In the case of a negative validation of the up-to-dateness of the at least one map, the automated driving mode may be terminated, for example, and a control of the vehicle may be transferred to a driver.

Depending on the result of the validation, further actions may be carried out or prompted within the scope of the method. Such actions may include, for example, noting the inconsistency between the map and the actual vehicle surroundings, sending a report about the failed validation, initiating a remapping on-board the vehicle, initiating a remapping off-board the vehicle, carrying out a map update and the like. An up-to-dateness of a digital map may, in particular, be confirmed by the method or a lack of up-to-dateness of the digital map may be established.

The quality of digital maps, in particular, for automated driving, may be improved by the method. By the controlled transfer of measured data of the vehicle sensors, the updating of the digital map may be reduced to necessary areas. As a result, the map production may be accelerated in a targeted manner and the time it takes to provide up-to-date maps may be reduced. Moreover, the transfer of pieces of information relevant to the mapping may be controlled in a situation-dependent manner. This may reduce the volume of data to be transferred.

Moreover, the reliability of HAD maps and thus also the trustworthiness of the localization may be increased by the method according to the present invention.

According to one specific embodiment of the present invention, the up-to-dateness of the digital map is confirmed if the ascertained vehicle position within the digital map corresponds to the data of the driving assistance function. In this way, a consensus may be established between the digital map and the real vehicle surroundings. The at least one digital map may be successfully validated if, for example, the position in a localization map as well as the results of the driver assistance functions are able to correspondingly ascertain a negotiable position of the vehicle. In such a case, a planning map in parallel to the localization map may also be confirmed. This information may now be used locally or on-board the vehicle as well as off-board the vehicle. The positive validation of the digital map may, in particular, trigger a vehicle-internal on-board use of the digital map and/or a data upload.

In addition, a volume of data that is transferred by the control unit to an external server unit may be reduced, since the measured data of the vehicle sensor system are transferred to the external server unit only when needed or in the case of a negative validation of the at least one digital map. In this way, the scope and the frequency of such a sensor data transfer may also be reduced. Thus, a transfer of data between the control unit and the external server unit may be prevented if the digital map is still correct and therefore no map update is necessary.

According to one further exemplary embodiment of the present invention, the validation of the up-to-dateness of the digital map is negative if a discrepancy between the ascertained vehicle position within the digital map and the data of the driving assistance function is established. In this way, a disagreement between the at least one digital map and the vehicle surroundings may be established. Such a case occurs, for example, when a driving assistance function implemented as a lane-keeping assistant enables a continuous lane guidance while a localization service recognizes a departure from the lane or is unable to ascertain any valid position. Such a case may occur, in particular, in construction site situations, for example, when detouring onto an opposing roadway or onto an emergency lane.

If such a disagreement is ascertained by the control unit, the vehicle may no longer rely on the digital map, as a result of which the safety of an automated driving mode of the vehicle may no longer be ensured.

If a change of a digital map designed as a localization map is recognized, it may be deduced therefrom that in all likelihood a planning map for the same location has also changed and a new production of the relevant area is necessary.

According to one further specific embodiment of the present invention, an external server unit is notified once a discrepancy between the ascertained vehicle position within the digital map and the data of the driving assistance function is established. In this way, the external server unit which, for example, receives measured data from a plurality of vehicles and produces digital maps from the measured data, may be notified or alerted.

This may trigger a remapping of the relevant area of the vehicle surroundings. In addition, the vehicle surroundings, which are no longer correctly stored in the digital map, may be marked for all vehicles as invalid and/or as no longer up-to-date.

According to one further exemplary embodiment of the present invention, a map update and/or a remapping is/are initiated once a discrepancy between the ascertained vehicle position within the digital map and the data of the driving assistance function is established. A piece of information about the established discrepancy may thus be transferred via a wireless communication link to the external server. Based on the transferred information, the external server may obtain measured data of vehicles from this area in a targeted manner and thereby correct the no longer up-to-date section of the digital map. In this way a situation-dependent map update may be carried out, which may be initiated when needed.

According to one further specific embodiment of the present invention, the discrepancy between the ascertained vehicle position within the digital map and the data of the driving assistance function is assessed and/or categorized. In this way, a severity of the discrepancy may be ascertained. The severity or the degree of the discrepancy may be determined by the control unit, for example, based on an impact on vehicles and on an automated operating mode. Discrepancies, for example, at reflector posts or at a roadway edge may be classified as minor. Other discrepancies such as, for example, changed lane guidance, blocked lanes and the like may be classified as serious. As a result of such a categorization of the ascertained discrepancies, the transferred volume of data may be further reduced, since only serious discrepancies are reported to the external server unit.

According to one further specific embodiment of the present invention, the established discrepancy is stored in a memory connectable to the control unit. In this way, the discrepancies classified, in particular, as minor may initially be noted on-board the vehicle, since these have no direct influence or only a minor influence on the traffic. With a renewed passing of the vehicle surroundings with the discrepancy classified as minor between the digital map and the vehicle surroundings, a notification may be transferred by the control unit to the external server unit if the discrepancy persists. In this way, minor discrepancies may be continuously observed, as a result of which changes in the influence of the discrepancy on vehicles may be recognized in a timely manner and taken into account during the map update.

### BRIEF DESCRIPTION OF THE DRAWINGS

Preferred exemplary embodiments are explained in greater detail below with reference to highly simplified schematic representations.

FIG. 1 schematically shows a representation of a vehicle system for illustrating a method according to one specific embodiment of the present invention.

FIG. 2 schematically shows a flowchart for illustrating the method in accordance with an example embodiment of the present invention.

### DETAILED DESCRIPTION OF EXAMPLE EMBODIMENTS

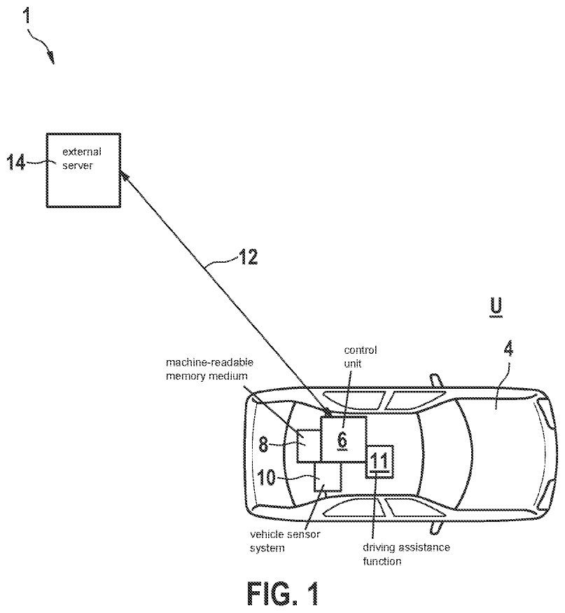

A schematic representation of a vehicle system 1 is shown in FIG. 1 for illustrating a method 2 according to one specific embodiment. Vehicle system 1 includes at least one vehicle 4, which drives along vehicle surroundings U in an automated driving mode.

Vehicle 4 includes an on-board control unit 6, which is configured to carry out method 2. For this purpose, control unit 6 may access a machine-readable memory medium 8, on which at least one computer program is stored. Control unit 6 may preferably carry out the computer program stored on machine-readable memory 8.

In addition, vehicle 4 includes a vehicle sensor system 10. Vehicle sensor system 10 may, for example, be made up of one or multiple LIDAR sensors, radar sensors, camera sensors, GNSS sensors and the like. Vehicle sensor system 10 may, in particular, collect measured data on vehicle surroundings U. The ascertained measured data may be transferred to control unit 6 and evaluated by control unit 6.

A driving assistance function 11 or a driving assistance system of vehicle 4 may also access the measured data of vehicle sensor system 10. Driving assistance function 11 may, for example, be a lane-keeping assistant, which checks whether vehicle 4 is situated within a negotiable lane. Driving assistance function 11 may, for example, detect roadway markings and/or lane markings and/or a road pavement, in order to establish a negotiability of vehicle surroundings U.

Control unit 6 may send data to an external server unit 14 via a communication link 12 or receive data from external server unit 14.

For example, control unit 6 may receive digital maps and/or map updates from external server unit 14. In addition, control unit 6 may send the received measured data of vehicle sensor system 10 to external server unit 14.

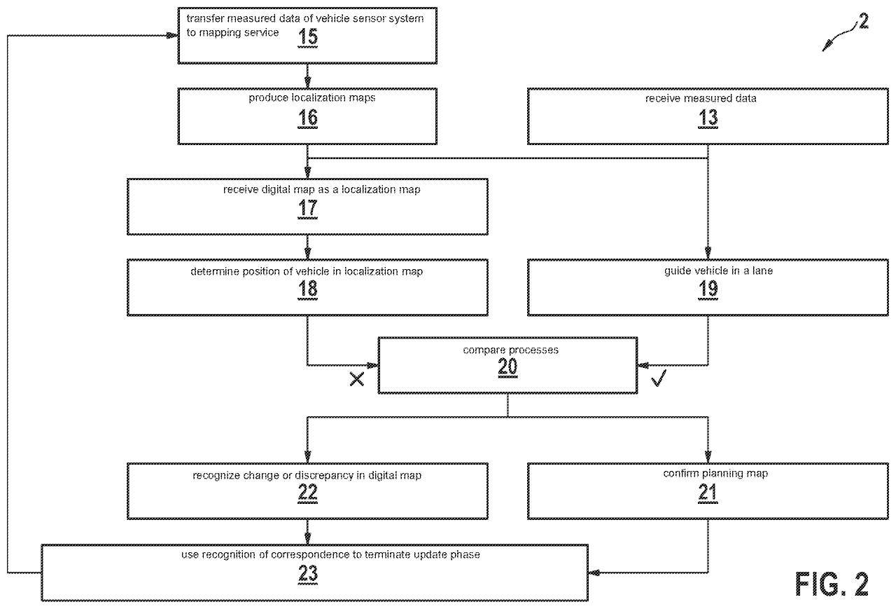

FIG. 2 schematically shows a flowchart for illustrating method 2.

In one step of method 2, measured data of vehicle sensor system 10 are initially detected by a mapping vehicle or a mapping fleet and transferred to a mapping service 15. Vehicle 4 may also be designed as a mapping vehicle or may be used as such.

From the received measured data, external server unit 14 may, for example, produce localization maps 16. The localization map may be designed preferably as a digital map and may be provided to vehicles for localization.

During driving, the digital map designed as a localization map is received 17 by a localization service. A position of vehicle 4 in localization map 18 is determined continuously by the localization service. For this purpose, measured data of vehicle sensor system 10 in addition to the localization map may be received 13 and used. A situation analysis takes place in parallel to the ascertainment of vehicle position 18 based on existing driver assistance functions of vehicle 4. For example, lane-keeping assistants, emergency braking assistants, distance-keeping assistants, sign recognition assistants and the like may be utilized as driving assistance functions. Vehicle 4 may be guided 19 in a lane based on the results of the driver assistance function.

Both processes 18, 19 will be compared 20 with one another below. A consensus or a positive validation of the up-to-dateness of the map may be ascertained if both a vehicle position in the localization map as well as the results of the driver assistance functions are able to correspondingly ascertain a negotiable position. In this case, planning map is confirmed 21.

A disagreement or a negative validation may, for example, be ascertained by control unit 6 if the lane-keeping assistant enables a continuous lane guidance, whereas the localization service recognizes a departure from the lane or is unable to ascertain any valid position. Such a situation may arise, in particular, in construction site situations such as, for example, when detouring onto an opposing roadway. A change or discrepancy of the digital map may be recognized 22. This information may now also be transferred locally by control unit 6 and/or to a so-called mapping service 15, for example, of external server unit 14.

Once the results of the situation analysis of the driving assistance function or of a driving assistance system are compared continuously with the localization map, the recognition of a correspondence may be used to terminate an update phase 23.

1-10. (canceled)

11. A method for validating an up-to-dateness of at least one digital map by a control unit, comprising the following steps:
receiving or retrieving the at least one digital map;
receiving measured data on surrounds of the vehicle;
ascertaining a vehicle position within the at least one digital map based on landmarks within the vehicle surroundings detected based on the measured data;
receiving data of a driving assistance function; and
validating the up-to-dateness of the at least one digital map by carrying out a comparison between the ascertained vehicle position within the at least one digital map and the data of the driving assistance function.

12. The method as recited in claim 11, wherein the up-to-dateness of the digital map is confirmed when the ascertained vehicle position within the digital map corresponds to the data of the driving assistance function.

13. The method as recited in claim 11, wherein the validation of the up-to-dateness of the digital map is negative when a discrepancy between the ascertained vehicle position within the digital map and the data of the driving assistance function is established.

14. The method as recited in claim 13, further comprising:
notifying an external server unit via a communication link after the discrepancy between the ascertained vehicle position within the digital map and the data of the driving assistance function is established.

15. The method as recited in claim 13, wherein a map update and or a remapping is initiated after a discrepancy between the ascertained vehicle position within the digital map and the data of the driving assistance function is established.

16. The method as recited in claim 13, wherein the discrepancy between the ascertained vehicle position within the digital map and the data of the driving assistance function is assessed and/or categorized.

17. The method as recited in claim 13, wherein the established discrepancy is stored in a memory connectable to the control unit.

18. A control unit configured to validate an up-to-dateness of at least one digital map, the control unit configured to:
receive or retrieving the at least one digital map;
receive measured data on surrounds of the vehicle;
ascertain a vehicle position within the at least one digital map based on landmarks within the vehicle surroundings detected based on the measured data;
receive data of a driving assistance function; and
validate the up-to-dateness of the at least one digital map by carrying out a comparison between the ascertained vehicle position within the at least one digital map and the data of the driving assistance function.

19. A non-transitory machine-readable memory medium on which is stored a computer program for validating an up-to-dateness of at least one digital map, the computer program, when executed by a computer or control unit, causing the computer or control unit to perform the following steps:
receiving or retrieving the at least one digital map;
receiving measured data on surrounds of the vehicle;
ascertaining a vehicle position within the at least one digital map based on landmarks within the vehicle surroundings detected based on the measured data;
receiving data of a driving assistance function; and
validating the up-to-dateness of the at least one digital map by carrying out a comparison between the ascertained vehicle position within the at least one digital map and the data of the driving assistance function
